(19) United States
(12) Patent Application Publication
(10) Pub. No.: US 2017/0036633 A1
(43) Pub. Date: Feb. 9, 2017

(54) OCCUPANT PROTECTION DEVICE

(71) Applicant: Toyota Jidosha Kabushiki Kaisha, Toyota-shi (JP)

(72) Inventors: Ippei KOBAYASHI, Okazaki-shi (JP); Mitsuyoshi Ohno, Miyoshi-shi (JP); Atsushi Nakashima, Toyota-shi (JP)

(73) Assignee: Toyota Jidosha Kabushiki Kaisha, Toyota-shi (JP)

(21) Appl. No.: 15/180,204

(22) Filed: Jun. 13, 2016

(30) Foreign Application Priority Data
Aug. 7, 2015 (JP) 2015-157160

(51) Int. Cl. B60R 21/18; B60R 21/207

(52) U.S. Cl. CPC B60R 21/18; B60R 21/207

(57) ABSTRACT

An occupant protection device includes a vehicle seat including a pair of side supports each provided on a seat cushion so as to be capable of supporting a seated occupant from a side, a seatbelt including a lap belt for waist restraint of the occupant, and an airbag that is provided at the seat cushion, that is capable of receiving a supply of gas and inflating, that is disposed in a position such that, at a time of inflation, at least a portion of the airbag overlaps with the lap belt in an occupant-worn state thereof, in a side view of the seat, and that, by inflating, causes the side support to be displaced and applies tension to the lap belt.

### CROSS-REFERENCE TO RELATED APPLICATION

This application claims priority under 35 USC 119 from Japanese Patent Application No. 2015-157160 filed on Aug. 7,2015, the disclosure of which is incorporated by reference herein

### BACKGROUND

Technical Field

The present invention relates to an occupant protection device.

Description of the Related Art

Japanese Patent Application Laid-Open (JP-A) No. 2010-64632 describes a configuration in which, in order to suppress displacement of an occupant relative to a vehicle seat resulting from a collision, a side support of a seat cushion is caused to jut out toward the vehicle upper side by inflating an airbag disposed inside the side support, and the leg of the occupant is supported from a side.

### SUMMARY OF THE INVENTION

However, there is still room for improvement regarding improving occupant protection performance in consideration of a worn state of the seatbelt by the occupant.

An object of an exemplary embodiment of the present invention is to improve occupant protection performance in a seatbelt worn state.

### Solution to Problem

An occupant protection device according to a first aspect of the present invention includes a vehicle seat including a pair of side supports each provided on a seat cushion so as to be capable of supporting a leg of a seated occupant from a side, a seatbelt including a lap belt for waist restraint of the occupant, and an airbag that is provided at the seat cushion, that is capable of receiving a supply of gas and inflating, that is disposed at a position such that, at a time of inflation, at least a portion of the airbag overlaps with the lap belt, in an occupant-worn state thereof, in a side view of the seat, and that, by inflating, causes the side support to be displaced and applies tension to the lap belt.

In this occupant protection device, in a state in which the occupant seated in the vehicle seat wears the seatbelt with the waist of the occupant restrained by the lap belt, when the airbag provided at the seat cushion inflates, the side support is displaced due to the inflation of the airbag, and this applies tension to the lap belt. The airbag is disposed at a position such that, at a time of inflation, at least a portion of the airbag overlaps with the lap belt in a side view of the seat, and a location of the side support between the lap belt and the airbag is thereby easily displaced toward the lap belt side. This improves occupant restraint performance since the tension on the lap belt increases.

A second aspect is the occupant protection device according to the first aspect, wherein the airbag is disposed at a position that, at a time of inflation, intersects with the lap belt in a side view of the seat.

In this occupant protection device, since the airbag is disposed at the position that, at a time of inflation, intersects with the lap belt in the side view of the seat, a wider range of the side support is displaced toward the lap belt side due to the inflation of the airbag. This further improves occupant restraint performance since greater tension is placed on the lap belt.

A third aspect is the occupant protection device according to the first or the second aspect, wherein the airbag, at a time of inflation, displaces the side support at least toward a seat upper side, and supports the lap belt using the side support.

In this occupant protection device, since the side support is displaced toward at least the seat upper side by the inflation of the airbag, the gap between the lap belt, the leg, and the seat cushion present prior to inflation of the airbag is reduced by the displacement of the side support. The leg of the occupant is thus supported from the side by the side support. Moreover, since the lap belt is supported by the side support, tension is placed on the lap belt. The occupant restraint performance is accordingly further improved

### Advantageous Effects of Invention

The occupant protection device according to the first aspect obtains the excellent advantageous effect of enabling occupant protection performance to be improved in the seatbelt worn state.

The occupant protection device according to the second aspect obtains the excellent advantageous effect of enabling occupant protection performance to be further improved in the seatbelt worn state

The occupant protection device according to the third exemplary embodiment obtains the excellent advantageous effect of enabling the occupant protection performance to be still further improved in the seatbelt worn state.

### BRIEF DESCRIPTION OF DRAWINGS

FIG. 1 is a side view illustrating an occupant protection device according to an exemplary embodiment.

FIG. 2 is a cross-section illustrating an ordinary state of an occupant protection device according to an exemplary embodiment.

FIG. 3 is a cross-section illustrating a state in which an airbag has been inflated, and tension has been placed on a lap belt, in an occupant protection device according to an exemplary embodiment.

### DETAILED DESCRIPTION OF PREFERRED EMBODIMENTS

Explanation follows regarding an exemplary embodiment of the present invention, based on the drawings. In the drawings, the arrow FR indicates a seat front side, the arrow UP indicates a seat upper side, and an arrow RH indicates a seat right side, with a vehicle seat 12 as a reference. The seat upper side also corresponds to an upper side of the vehicle (omitted from illustration in the drawings). When the seat front side corresponds to the vehicle front side, the arrow FR also denotes the vehicle front side, and the arrow RH also denotes the vehicle right side.

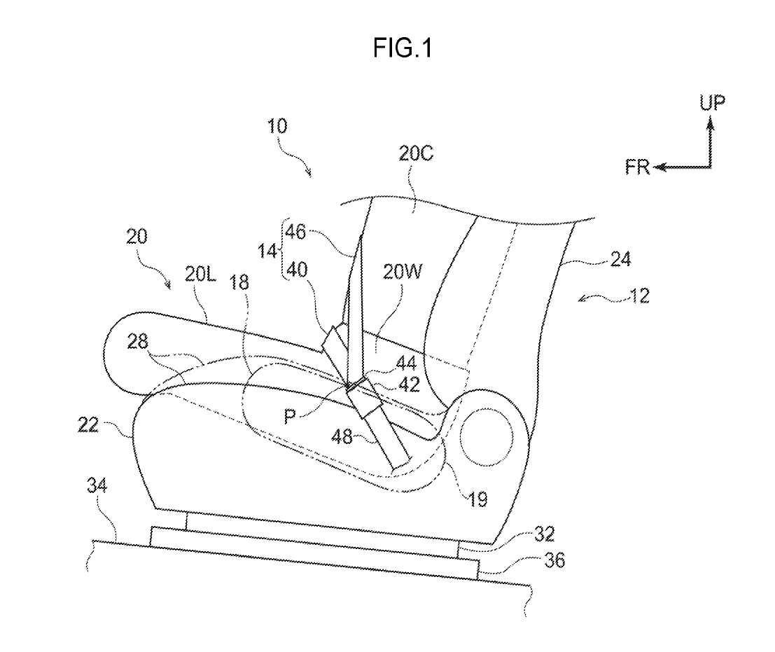

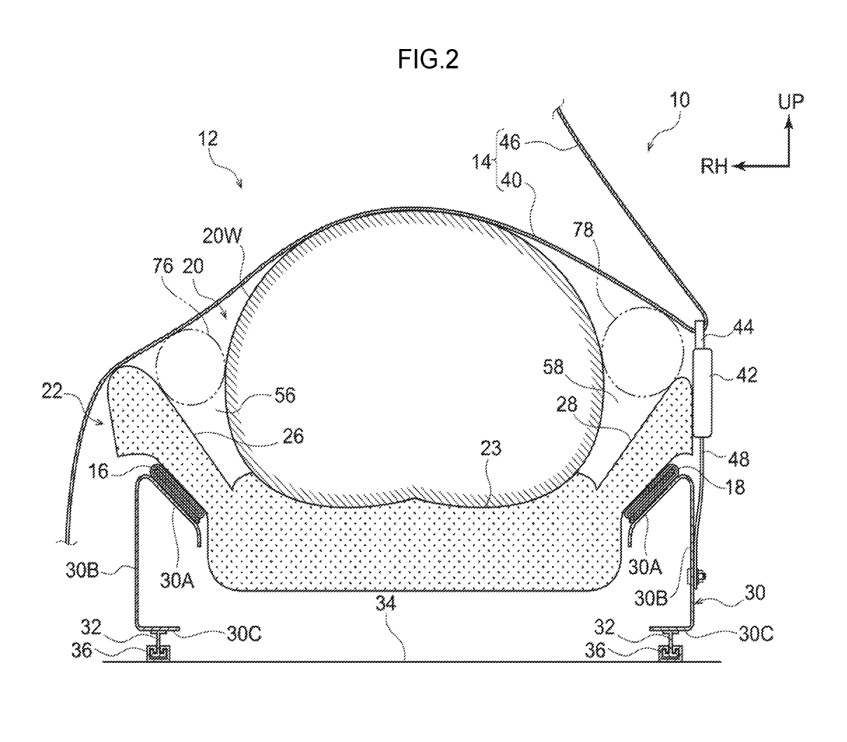

In FIG. 1, an occupant protection device 10 according to the present exemplary embodiment includes the vehicle seat 12, a seatbelt 14, and airbags 16, 18 (FIG. 2).

In FIG. 1, the vehicle seat 12 is a seat provided to a vehicle, which is omitted from illustration in the drawings. The vehicle seat 12 includes a seat cushion 22 on which an occupant 20 sits, and a seat back 24 forming a backrest for the occupant 20. As illustrated in FIG. 2, on the seat cushion 22, the vehicle seat 12 also includes a pair of side supports 26, 28 provided so as to be capable of supporting the legs 20L of the seated occupant 20 (FIG. 1) from the sides. The seat cushion 22 is mostly constituted by a resilient body such as a foamed resin or fibers, and the pair of side supports 26, 28 are integrally provided at both seat width direction end portions of a main body portion 23, which forms the seat face for the occupant 20. The side supports 26, 28 extend in the seat front-rear direction, are locations projecting out toward further toward the seat upper side than the main body portion 23, and can be resiliently displaced in the seat up-down direction relative to the main body portion 23.

The seat cushion 22 is, for example, supported by a seat frame 30. The seat frame 30 is formed by, for example, a metal plate with a closed cross-section profile, and integrally includes inclined portions 30A, side wall portions 30B, and bottom portions 30C. The inclined portions 30A, for example, support both end portions in the seat width direction of the seat cushion 22, and more specifically, support sections corresponding to the side supports 26, 28, and each of the inclined portions 30A inclines toward the seat lower side from an outer side to an inside in the seat width direction. Legs 32 of the vehicle seat 12 are provided at the bottom portions 30C. The side wall portions 30B are at locations coupling both seat width direction outer side ends of the inclined portions 30A and the bottom portions 30C together in the seat up-down direction. The legs 32 are supported by seat rails 36 provided at the floor 34 of the vehicle.

In FIG. 1 and FIG. 2, the seatbelt 14 is a belt shaped member (webbing) for restraining the occupant 20 in the vehicle seat 12, and has flexibility. The seatbelt 14 has a structure with little extendability, so as to reduce stretching when restraining the occupant. The seatbelt 14 also includes a lap belt 40 for restraining the waist of the occupant 20. Namely, the lap belt 40 is webbing for restraining a waist 20W of the occupant 20. Although omitted from illustration in the drawings, a lower end of the seatbelt 14 is fixed to the floor 34 or to one side wall portion 30B of the seat frame 30.

The opposite side of a lower end the seatbelt 14 to a fixing side (omitted from illustration in the drawings) in the seat width direction is provided with a buckle device 42. The buckle device 42 is attached to an upper end portion of a stay 48, and a lower end portion 48A of the stay 48 is, for example, bolted to the side wall portion 30B of the seat frame 30. The seatbelt 14 passes through a tongue plate 44 that is insertable into the buckle device 42. In the worn state of the seatbelt 14, a portion from the fixing side of the lower end of the seatbelt 14 to the tongue plate 44 forms the lap belt 40. Moreover, a portion of the seatbelt 14 extending diagonally toward the upper side of the seat from the tongue plate 44 forms a chest belt 46 that restrains the chest 20C of the occupant 20. Namely, the seatbelt 14 according to the present exemplary embodiment is what is known as a three-point type.

In FIG. 2, the airbags 16, 18 are provided at the seat cushion 22, and, for example, are capable of receiving a supply of gas from a single inflator (omitted from illustration in the drawings) and inflating. The airbags 16, 18 are bag bodies that respectively displace the side supports 26, 28 by inflating, and apply tension to the lap belt 40. The airbags 16, 18 are, for example, respectively disposed in folded states between the inclined portions 30A of the seat frame 30 and bottom faces of the side supports 26, 28.

As illustrated in FIG. 1, the airbags 16, 18 are each disposed such that at least a portion thereof is at a position overlapping with the lap belt 40 in a side view of the seat, at a time of inflation, in an occupant-worn state of the lap belt 40. In the present exemplary embodiment, the airbags 16, 18 are disposed at positions that, at a time of inflation, intersect with the lap belt 40 in a side view of the seat (the overlap between the airbag 16 at the right side of the occupant 20 and the lap belt 40 is omitted from illustration in the drawings). Moreover, the airbags 16, 18 are disposed at positions that, at a time of inflation, intersect with the lap belt 40 in an occupant-worn state thereof, not only in a side view of the seat, but also in a plan view of the seat. Moreover, the airbags 16, 18 preferably inflate over a wide rage in the seat front-rear direction. The legs 20L of the occupant 20 are supported over a wide range at the sides by the side supports 26, 28, and improve the occupant protection performance during, for example, a side-on collision.

What is meant by the airbag 16 at the right side of the occupant 20 intersecting with the lap belt 40 is that the lap belt 40 runs across the airbag 16 in an inflated state thereof in a side view of the seat, and this means that the airbag 16 is present at both the seat front side and the seat rear side of the seatbelt 14. What is meant by the airbag 18 at the left side of the occupant 20 intersecting with the lap belt 40 is that the lap belt 40, and the tongue plate 44, the buckle device 42 and the stay 48, run across the airbag 18 in an inflated state thereof in a side view of the seat. Namely, this means that the airbag 18 is present at the lap belt 40, and spanning across from the seat front side to the seat rear side of a structure that supports the lap belt 40.

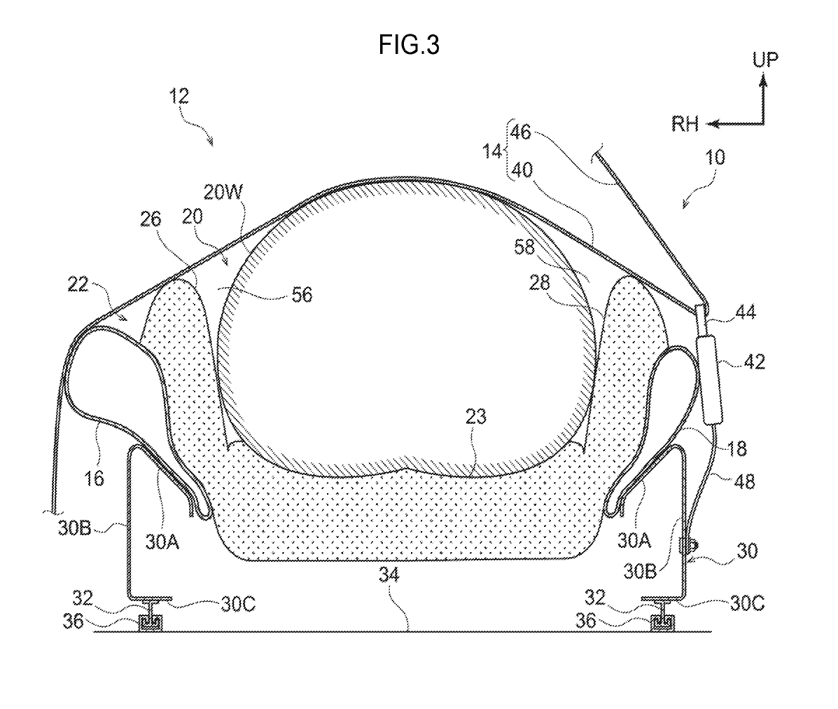

As illustrated in FIG. 3, the airbags 16, 18 displace the side supports 26, 28 at least toward the seat upper side at a time of inflation. The lap belt 40 is supported by the side supports 26, 28. In the seat cushion 22, the side supports 26, 28 are capable of being resiliently displaced in the seat up-down direction with respect to the main body portion 23. Accordingly, the airbags 16, 18 are inflated at the seat lower side of the side supports 26, 28 so as to displace the side supports 26, 28 toward the seat upper side, and the side supports 26, 28 are thereby displaced toward the seat upper side.

Setting the peripheral lengths of the airbags 16, 18 may be considered as an example of a means for causing the side supports 26, 28 to be displaced in this manner. As illustrated in FIG. 2, prior to inflation of the airbags 16, 18 (ordinarily), gaps 56, 58 are formed between the lap belt 40, the legs 20L, and the seat cushion 22. The peripheral length of the airbag 16 is set longer than the circumference of a circumcircle 76 of a triangle, where the circumcircle 76 is found for a triangle between the lap belt 40, the legs 20L, and the seat cushion 22 at the seat right side of the occupant 20. Similarly, the peripheral length of the airbag 18 is set longer than the circumference of a hypothetical circumcircle 78 of a triangle, where the circumcircle 78 is found for a triangle between the lap belt 40, the legs 20L, and the seat cushion 22 at the seat left side of the occupant 20. When this is performed, the build of the occupant 20 is considered to be that of a crash test dummy AF05 (American female 5^{th} percentile), with the occupant 20 seated at a seat width direction center.

### Operation

The present exemplary embodiment is configured as described above, and operation thereof is explained below. In the occupant protection device 10 according to the present exemplary embodiment of FIG. 2 and FIG. 3, in a state in which the occupant 20 seated in the vehicle seat 12 is wearing the seatbelt 14 such that the waist is restrained by the lap belt 40, the airbags 16, 18 provided at the seat cushion 22 inflate when, for example, a side-on collision occurs.

The side supports 26, 28 are displaced due to the airbags 16, 18 inflating, and this applies tension to the lap belt 40. More specifically, the lap belt 40 is pressed from the seat lower side by the side supports 26, 28 to an extent such that the lap belt 40 does not come away from the occupant 20, with this thereby reducing slack in the lap belt 40 and applying tension to the lap belt 40.

Note that in such an event, the airbags 16, 18 may directly contact the lap belt 40 or the buckle device 42. The reason for this is because it enables tension to be placed on the lap belt 40 by the airbags 16, 18 pressing on the lap belt 40 or the buckle device 42.

The airbags 16, 18 are each disposed such that, at a time of inflation, at least a portion thereof is at a position overlapping with the lap belt 40 in a side view of the seat, and moreover at a position intersecting with the lap belt 40 in a side view of the seat. Accordingly, a wide range of the side supports 26, 28 between the lap belt 40 and the airbags 16, 18 is easily displaced toward the lap belt 40 side. This improves occupant restraint performance since slack in the lap belt 40 is further reduced, and tension on the lap belt 40 is increased.

Moreover, the side supports 26, 28 are displaced at least toward the seat upper side by the inflation of the airbags 16, 18, thereby reducing the gaps 56, 58 (FIG. 2) between the lap belt 40, the legs 20L, and the seat cushion 22 present prior to inflation of the airbags 16, 18. The legs 20L of the occupant 20 are thus supported from the sides by the side supports 26, 28. Moreover, tension is placed on the lap belt 40 since the lap belt 40 is supported by the side supports 26, 28. The occupant restraint performance is thus further improved.

Accordingly, in the occupant protection device 10 according to the present exemplary embodiment, occupant protection performance can be improved when the seatbelt 14 is in a worn state.

### Other Exemplary Embodiments

Although explanation has been given above regarding an exemplary embodiment of the present invention, the exemplary embodiment of the present invention is not limited by the above description, and it is obvious that in addition to the above description, various modifications may be implemented within a range not departing from the spirit of the present invention.

Although the airbags 16, 18 are disposed at a position that, at a time of inflation, intersects the lap belt 40 in a side view of the seat, there is no particular need for this to be a total intersection. It is sufficient for the configuration to be such that at least a portion of each of the airbags 16, 18 is disposed at a position overlapping, in a side view of the seat, with the lap belt 40 in an occupant-worn state of the lap belt 40, such that tension can be placed on the lap belt 40 by displacing the side supports 26, 28. More specifically, it is sufficient for an end portion 19 at a seat rear side of the airbags 16, 18 to be in a position overlapping with the lap belt 40. In FIG. 1, regarding the side airbag 18 at the side of the left hand side of the occupant 20, it is sufficient that the end portion 19 at the seat rear side of the airbag 18, at a time of inflation, is disposed further to the seat back rear side than an intersection point P furthest to the seat front side from out of intersection points between the lap belt 40 and the airbag 18. Similar applies to the airbag 16 at the right side of the occupant 20.

At least a portion of the airbag 18 may be configured so as to be disposed at a position overlapping the buckle device 42 in a side view of the seat. This because tension can also be placed on the lap belt 40 by the buckle device 42 being pressed by the side support 28, and the stay 48 being displaced, such that the buckle device 42 is displaced toward the seat width direction outer side.

At a time of inflation, the airbags 16, 18 displace the side supports 26, 28 at least toward the seat upper side, and lap belt 40 is supported by the side supports 26, 28; however, the displacement direction of the side supports 26, 28 is not limited thereto. For example, a configuration may be employed in which the side supports 26, 28 are each displaced toward the seat width direction outer side during inflation and press against the lap belt 40, and tension is placed on the lap belt 40. A configuration may be employed in which, during inflation of the airbags 16, 18, the side supports 26, 28 are each displaced toward the seat upper side and the seat width direction outer side, namely, upward diagonally toward the seat width direction outer side.

The airbags 16, 18 may both be inflated simultaneously, or, in consideration of the type of collision, the positional relationship between the collision input side and the seating side of the occupant 20 in the vehicle, and the like, one airbag may be inflated and the other airbag may be inflated at a delay after the one airbag. When a side-on collision is given as an example, movement of the occupant 20 toward the collision side can be suppressed by inflating the airbag at the collision side, and movement of the occupant 20 toward the side opposite to the collision side can be suppressed by inflating the airbag at the side opposite to the collision side. Moreover, in consideration of the behavior of the occupant 20 during stages after the initial stage of the collision, the occupant protection performance can be further improved by changing the inflation timings of the pair of airbags.

Although, as the airbag, the pair of airbags 16, 18 were provided corresponding to the pair of side supports 26, 28, the airbag may be provided at one of the side supports alone. Moreover, the airbags 16, 18 are not limited to a single bag body each, and may each include plural bag bodies or inflating sections. Moreover, the airbags 16, 18 may be configured to inflate inside the seat cushion 22, so as not to be exposed to the exterior. As an example, the airbags 16, 18 may be disposed at positions covered by a cover (omitted from illustration in the drawings) of the seat cushion 22. In such cases, the cover of the seat cushion 22 is displaced by inflation of the airbags 16, 18, and tension is placed on the lap belt 40.

The seatbelt 14 is not limited to a three-point type that includes the lap belt 40 and the chest belt 46, and may be a two-point type that includes the lap belt 40 alone.

What is claimed is:

1. An occupant protection device, comprising:
a vehicle seat including a pair of side supports each provided on a seat cushion so as to be capable of supporting a leg of a seated occupant from a side;
a seatbelt including a lap belt for waist restraint of the occupant; and
an airbag that is provided at the seat cushion, that is capable of receiving a supply of gas and inflating, that is disposed at a position such that, at a time of inflation, at least a portion of the airbag overlaps with the lap belt, in an occupant-worn state thereof, in a side view of the seat, and that, by inflating, causes the side support to be displaced and applies tension to the lap belt.

2. The occupant protection device of claim 1, wherein the airbag is disposed at a position that, at a time of inflation, intersects with the lap belt in a side view of the seat.

3. The occupant protection device of claim 2, wherein the airbag is disposed at a position that, at a time of inflation, intersects with the lap belt in a plan view of the seat.

4. The occupant protection device of claim 1, wherein:
the seat cushion is supported by a seat frame that includes inclined portions;
the inclined portions are inclined toward a seat lower side from an outer side to an inside in a seat width direction, and are sections that support sections corresponding to the side supports of the seat cushion; and
the airbag is disposed in a folded state between the inclined portions and bottom faces of the side supports.

5. The occupant protection device of claim 1, wherein the airbag, at a time of inflation, displaces the side supports at least toward a seat upper side, and supports the lap belt using the side support.

6. The occupant protection device of claim 1, wherein the airbag, at a time of inflation, displaces the side supports at least toward a seat width direction outer side, and presses against the lap belt.
